(19) United States
(12) Patent Application Publication
(10) Pub. No.: US 2022/0168883 A1
(43) Pub. Date: Jun. 2, 2022

(54) SCREWDRIVER

(71) Applicant: Hui-Chen CHANG, New Taipei City (TW)

(72) Inventor: Wang-Lien CHANG, New Taipei City (TW)

(73) Assignee: Hui-Chen CHANG, New Taipei City (TW)

(21) Appl. No.: 17/105,947

(22) Filed: Nov. 27, 2020

(51) Int. Cl. B25G 1/08; B25B 15/02

(52) U.S. Cl. CPC B25G 1/085; B25B 15/02

(57) ABSTRACT

A screwdriver has a barrel, a screwdriver-bit assembly, and a push assembly. The screwdriver-bit assembly has a screwdriver-bit seat, multiple screwdriver-bit shafts, and multiple screwdriver-bit resilient elements. The screwdriver-bit seat is fixed in the barrel and has multiple locating holes. Each one of the screwdriver-bit shafts is slidably mounted through a respective one of the locating holes. The screwdriver-bit resilient elements abut the screwdriver-bit shafts such that the screwdriver-bit resilient elements tend to retract inside the barrel. The push assembly has an abutting mechanism, an abutting rod, and a plunger. The abutting rod is connected to the abutting mechanism and is selectively aligned with one of the screwdriver-bit shafts. A press of the plunger forces the screwdriver bit to protrude. Another press of the plunger makes the screwdriver-bit shaft retract inside the barrel and makes the abutting rod align with another one of the screwdriver-bit shafts.

### BACKGROUND OF THE INVENTION

### 1. Field of the Invention

The present invention relates to a screwdriver, especially to a screwdriver with multiple interchangeable screwdriver bits from which a user can choose.

### 2. Description of the Prior Arts

Conventional screwdriver sets, especially precision screw driver sets, are sold in two different kinds of packages to be operable with most fasteners. A first kind of the screw driver set includes multiple screwdrivers of different types placed inside a case. A second kind of the screw driver set includes different screwdriver-bits placed inside a case, wherein the screwdriver bits cannot be used independently, but need to be assembled to a screwdriver handle of the second kind of the screw driver set before use.

However, when tightening or loosening different screws, a user needs to switch to a corresponding screwdriver each time when using the first kind of the screw driver set. For the second kind of the screw driver set, the user still has to switch to a corresponding screwdriver bit each time when tightening or loosening different screws, which wastes time and affects work efficiency. Moreover, the screwdrivers and screwdriver bits are easily lost during use because it is a hassle to arrange all the screwdrivers and screwdriver bits properly in their cases.

To overcome the shortcomings, the present invention provides a screwdriver to mitigate or obviate the aforementioned problems.

### SUMMARY OF THE INVENTION

The main objective of the present invention is to provide a screwdriver that has multiple screwdriver bits of different types mounted inside the screwdriver and allowing a user to quickly switch from one of the screwdriver bits to another one of the screwdriver bits.

The screwdriver has a barrel, a screwdriver-bit assembly, and a push assembly. The barrel is annular to form an accommodating space therein. The barrel has an end opening and a mounting opening. The end opening and the mounting opening are respectively formed in two opposite ends of the barrel. The end opening and the mounting opening are connected to the accommodating space. An inner diameter of the barrel gradually reduces from the mounting opening toward the end opening. The screwdriver-bit assembly has a screwdriver-bit seat, multiple screwdriver-bit shafts, and multiple screwdriver-bit resilient elements. The screwdriver-bit seat is attached to a circumference of the mounting opening of the barrel. Multiple locating holes are formed through the screwdriver-bit seat. Each one of the locating holes is a polygonal hole. The screwdriver-bit shafts are mounted in the accommodating space via the mounting opening. Each one of the screwdriver-bit shafts is mounted through a respective one of the locating holes of the screwdriver-bit seat. Each one of the screwdriver-bit shafts has a screwdriver bit, a moving portion, and a flexible shaft. The screwdriver bit and the moving portion are respectively located on two opposite ends of the flexible shaft. The moving portion is mounted through the corresponding locating hole. Each one of the screwdriver-bit resilient elements is located around a respective one of the moving portions of the screwdriver-bit shafts. Two opposite ends of each one of the screwdriver-bit resilient elements are respectively a first end and a second end. The first end is attached to the screwdriver-bit seat. The second end is fixed to the corresponding moving portion. The push assembly has an abutting mechanism, an abutting rod, and a plunger. The abutting mechanism is connected to the screwdriver-bit seat. The abutting rod is mounted on one of two ends of the abutting mechanism and is selectively aligned with one of the screwdriver-bit shafts. An inner end of the plunger is connected to the other end of the abutting mechanism. When the screwdriver-bit shafts are retracted inside the barrel, a press of the plunger forces the abutting mechanism to abut against the abutting rod such that the screwdriver-bit shaft in alignment with the abutting rod protrudes from the end opening of the barrel. When one of the screwdriver-bit shafts protrudes from the end opening of the barrel, another press of the plunger makes said screwdriver-bit shaft retract inside the barrel and makes the abutting rod align with another one of the screwdriver-bit shafts.

The advantage of the present invention is that by accommodating different screwdriver-bit shafts inside the barrel, it is easier for a user to carry and store the screwdriver. Moreover, the user can quickly switch from one of the screwdriver bits to another one of the screwdriver bits during use, thereby further improving use efficiency. The cap prevents the user from accidentally pressing the plunging rod when not in use, thereby preventing the screwdriver bits from protruding or retracting unexpectedly.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a screwdriver in accordance with the present invention;

FIG. 2 is an exploded view of the screwdriver in FIG. 1;

FIG. 3 is an exploded view of a push assembly in FIG. 2;

FIG. 4 is another exploded view of the push assembly in FIG. 2, viewed from another angle;

FIG. 5 is another exploded view of a screwdriver-bit assembly in FIG. 2;

FIG. 6 is a partial longitudinal cross-sectional view of the screwdriver in FIG. 1;

FIG. 7 is another partial longitudinal cross-sectional view of the screwdriver in FIG. 1;

FIG. 8 is a transverse cross-sectional view of the screwdriver in FIG. 1;

FIG. 9 is a schematic side view of the screwdriver in a retracted state;

FIG. 10 is a schematic side view of the screwdriver, showing a plunger being pressed; and

FIG. 11 is a schematic side view of the screwdriver in a protruded state.

### DETAILED DESCRIPTION OF THE PREFERRED EMBODIMENTS

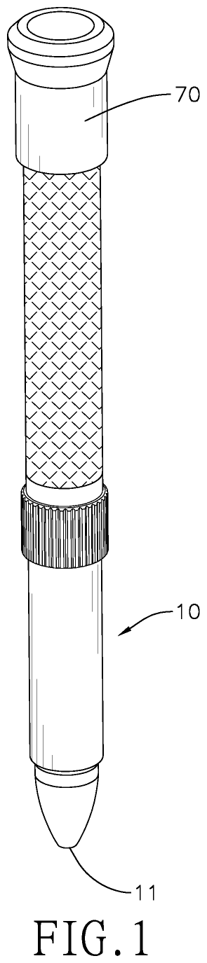

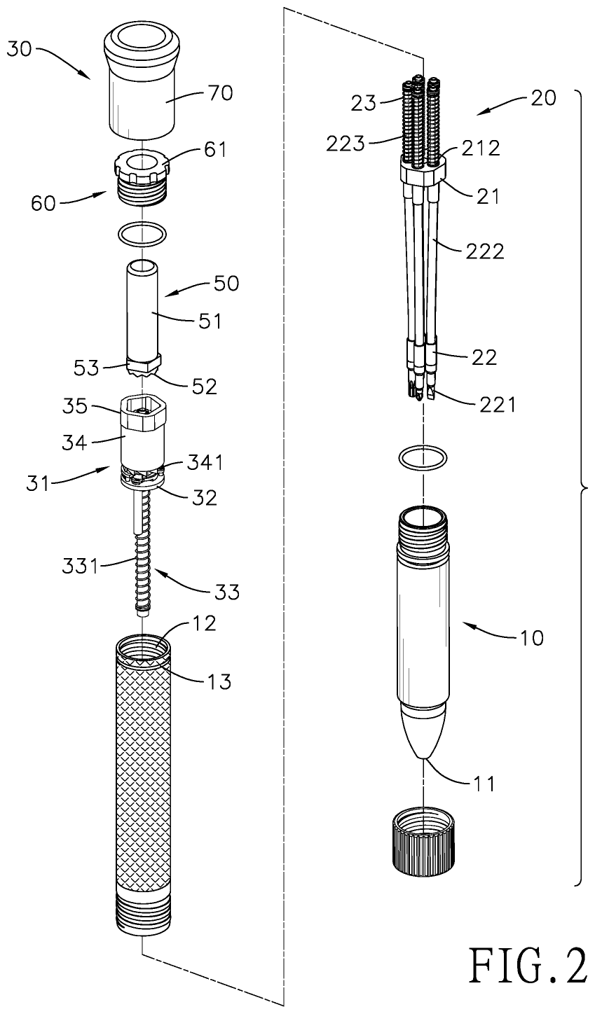

With reference to FIG. 1 and FIG. 2, a screwdriver in accordance with the present invention comprises a barrel 10, a screwdriver-bit assembly 20, and a push assembly 30.

With reference to FIG. 2, the barrel 10 is a hollow tube to form an accommodating space therein. An end opening 11 and a mounting opening 12 are respectively formed in two opposite ends of the barrel 10. The end opening 11 and the mounting opening 12 are connected to the accommodating space. An inner diameter of the barrel 10 gradually reduces in a direction from the mounting opening 12 toward the end opening 11. An engaging recess 13 is annularly formed in an outer surface of the barrel 10. The engaging recess 13 is adjacent to the mounting opening 12. An inner thread is formed in an inner surface of the barrel 10. The inner thread is adjacent to the mounting opening 12. A polygonal portion is formed on the inner surface of the barrel 10.

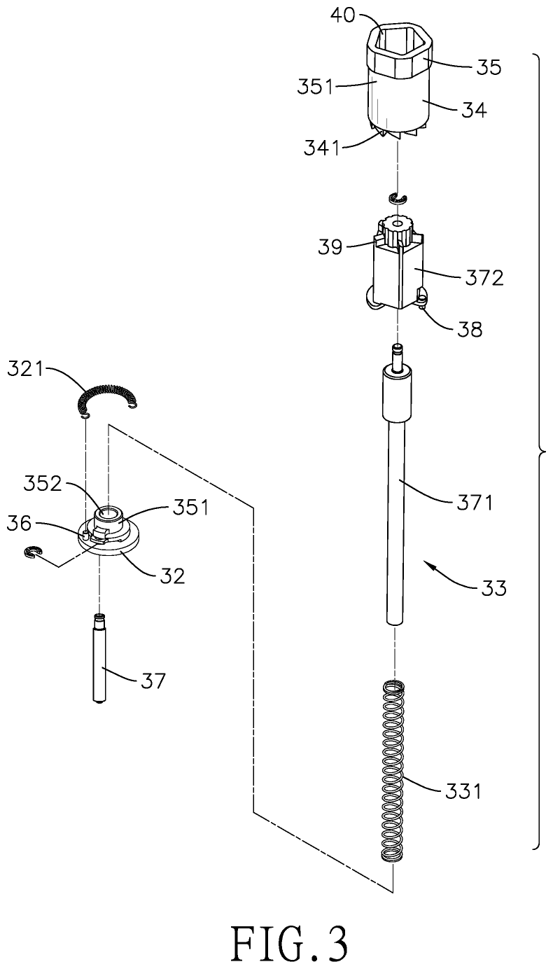

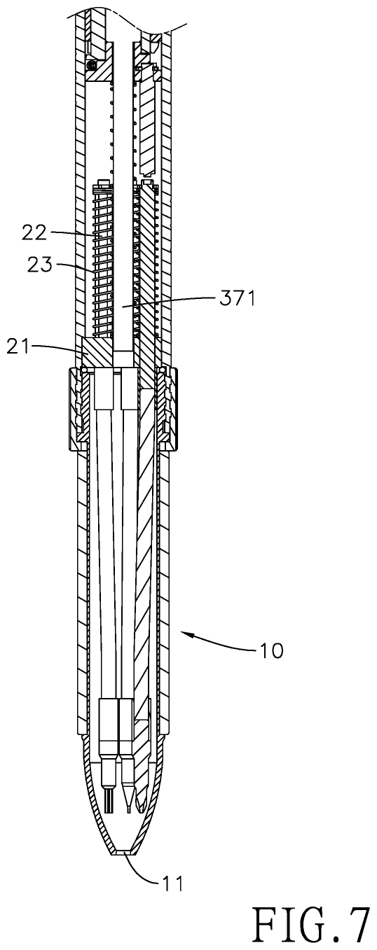

With reference to FIGS. 2, 3, and 7, the screwdriver-bit assembly 20 has a screwdriver-bit seat 21, multiple screwdriver-bit shafts 22 and multiple screwdriver-bit resilient elements 23. The screwdriver-bit seat 21 is a block having a polygonal annular side surface, and said annular side surface corresponds in shape to the polygonal portion of the barrel 10.

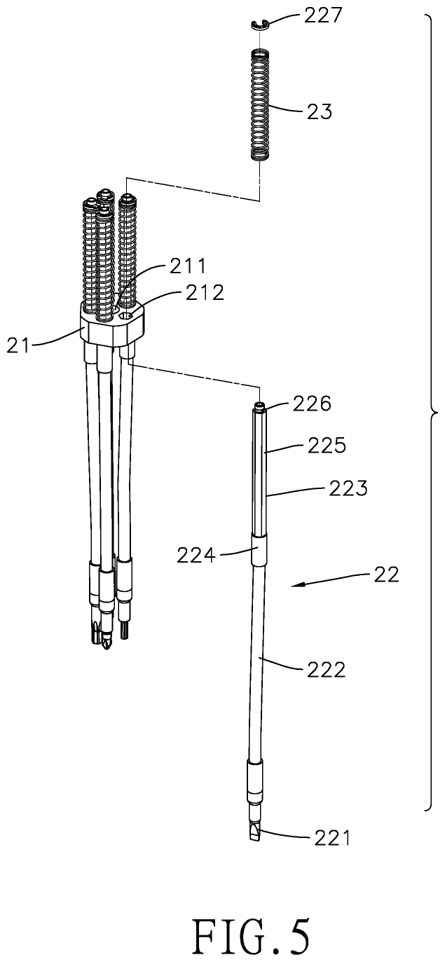

With reference to FIG. 5, a center hole 211 and multiple locating holes 212 are formed through the screwdriver-bit seat 21. The center hole 211 is located in a center of the screwdriver-bit seat 21, and the locating holes 212 are annularly disposed apart from each other around the center hole 211. Each one of the locating holes 212 is a polygonal hole.

Each one of the screwdriver-bit shafts 22 has a screwdriver bit 221, a flexible shaft 222, and a moving portion 223; the screwdriver bit 221 and the moving portion 223 are located on two opposite ends of the flexible shaft 222. The screwdriver bits 221 of the screwdriver-bit shafts 22 are conventional, and therefore detailed structure of the screwdriver bits 221 will not be further described. The flexible shaft 222 is a flexible rod. An end of the screwdriver bit 221 is fixed to the flexible shaft 222.

Each one of the moving portions 223 has a stopper 224, a sliding rod 225, an engaging portion 226, and an engaged part 227. The stopper 224 is a rod, and a diameter of the stopper 224 is larger than a diameter of the corresponding flexible shaft 222. An end of the stopper 224 is fixed to another end of said flexible shaft 222. The sliding rod 225 is a polygonal rod corresponding in shape to one of the locating holes 212. An end of the sliding rod 225 is fixed to another end of the stopper 224. The engaging portion 226 is an annular groove formed in another end of the sliding rod 225.

Each one of the screwdriver-bit resilient elements 23 is a compression spring. The moving portion 223 of each one of the screwdriver-bit shafts 22 is mounted through a respective one of the locating holes 212 of the screwdriver-bit seat 21 until the corresponding stopper 224 is attached to a side surface of the screwdriver-bit seat 21.

Each one of the screwdriver-bit resilient elements 23 is located around a respective one of the moving portions 223 of the screwdriver-bit shafts 22. Two opposite ends of each one of the screwdriver-bit resilient elements 23 are respectively a first end and a second end. The first ends of the screwdriver-bit resilient elements 23 are attached to another side surface of the screwdriver-bit seat 21. Each one of the engaged parts 227 is a circlip snapped into a respective one of the engaging portions 226 (as shown in FIG. 5).

The second end of each one of the screwdriver-bit resilient elements 23 abuts against a side surface of the corresponding engaged part 227 such that the screwdriver-bit resilient element 23 is located between the screwdriver-bit seat 21 and the engaged part 227. The screwdriver-bit shafts 22 are mounted in the accommodating space via the mounting opening 12. The screwdriver-bit seat 21 is attached to an inner surface of the barrel 10 to prevent the screwdriver-bit seat 21 from rotating relative to the barrel 10.

With reference to FIGS. 2 to 4, the push assembly 30 has an abutting mechanism 31, a plunger 50, an axial fixing cylinder 60, and a cap 70. The abutting mechanism 31 has a rotated seat 32, a connecting resilient element 321, a switching module 33, a switching resilient element 331, and an outer cam cylinder 34. The rotated seat 32 has a top surface and a bottom surface. A mounting cylinder 351 and a first connecting pin 36 are formed on and protrude from said top surface. The mounting cylinder 351 is hollow and has a mounting hole 352 formed through a center of the rotated seat 32. The first connecting pin is located outside of the mounting cylinder 351.

An abutting rod 37 is mounted on a bottom surface of the rotated seat 32 and protrudes from said bottom surface. The abutting rod 37 is adjacent to a circumference of the bottom surface. In other words, a position of the abutting rod 37 deviates from the center of the rotated seat 32. The connecting resilient element 321 is a tension spring. One of two ends of the connecting resilient element 321 is hooked to the first connecting pin 36.

The switching module 33 has an aligning rod 371 and a cam-follower block 372 that are respectively located on two opposite ends of the switching module 33. The cam-follower block 372 protrudes from the switching module 33 and surrounds the switching module 33. A second connecting pin 38 and multiple follower teeth 39 protrude from the cam-follower block 372. The second connecting pin 38 extends toward the aligning rod 371, and the other end of the connecting resilient element 321 is hooked to the second connecting pin 38.

The follower teeth 39 are annularly disposed apart from each other around the cam-follower block 372, and extend along an axial direction of the cam-follower block 372. The follower teeth 39 are annularly disposed apart from each other around the cam-follower block 372, and extend along the axial direction of the cam-follower block 372. The aligning rod 371 of the switching module 33 is mounted through the mounting hole 352 of the mounting cylinder 351, and the cam-follower block 372 is attached to the mounting cylinder 351.

The switching resilient element 331 is a compression spring and mounted around the aligning rod 371 of the switching module 33. The aligning rod 371 is mounted in the center hole 211 of the screwdriver-bit seat 21 such that the switching resilient element 331 is located between the screwdriver-bit seat 21 and the rotated seat 32.

With reference to FIGS. 2, 4, and 5, the outer cam cylinder 34 is hollow and has a cam end 341 and a mounting end 35. The cam end 341 and the mounting end 35 are formed respectively on two opposite ends of the outer cam cylinder 34. Multiple outer cam teeth are formed on the cam end 341. The mounting end 35 is a polygonal ring.

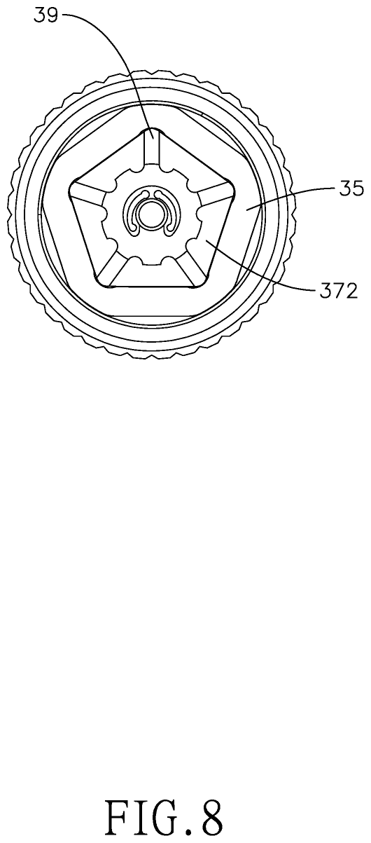

With reference to FIG. 8, the mounting end 35 corresponds in shape to the follower teeth 39. Multiple limit grooves 40 are formed in an inner surface of the outer cam cylinder 34 and extend along an axial direction of the outer cam cylinder 34. A number of the limit grooves 40 equals a number of the follower teeth 39, and each one of the limit grooves 40 corresponds in shape to a respective one of the follower teeth 39. Each one of the limit grooves 40 is disposed between two adjacent ones of the outer cam teeth. That is, one of the outer cam teeth is disposed between two adjacent ones of the two limit grooves 40. The cam end 341 of the outer cam cylinder 34 is located around the cam-follower block 372, and an annular side surface of the cam-follower block 372 is tightly attached to the limit grooves 40 such that the cam-follower block 372 is capable of moving along the axial direction of the outer cam cylinder 34 but incapable of rotating relative to the outer cam cylinder 34. A number of the outer cam teeth is twice the number of the follower teeth 39.

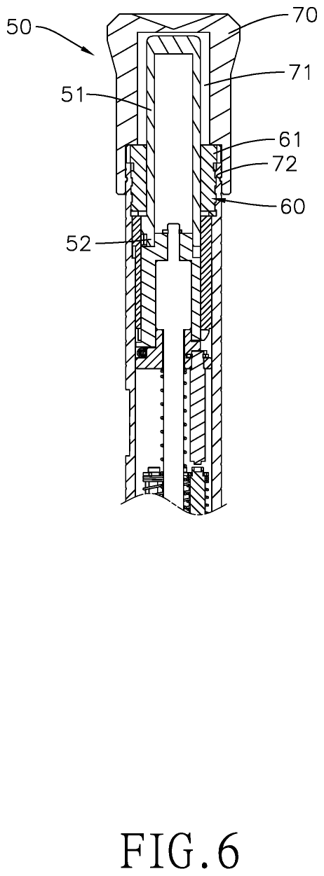

With reference to FIGS. 2 and 6, the plunger 50 is a cylinder. A plunging rod is formed on an outer end of the plunger 50, while multiple inner-cam teeth 52 and a limit portion 53 are formed on an inner end of the plunger 50. The inner-cam teeth 52 are formed on an end surface of the plunger 50 and annularly arranged around a center of said end surface. The limit portion 53 has a polygonal outer annular surface around the plunger 50, and corresponds in shape to the mounting end 35 of the outer cam cylinder 34. The limit portion 53 is mounted in the mounting end 35 and is attached to an inner surface of the mounting end 35.

The axial fixing cylinder 60 is hollow. A hand-turning ring 61 is formed on an outer end of the axial fixing cylinder 60, and an external thread is formed on an inner end of the axial fixing cylinder 60. Multiple friction recesses are formed in the hand-turning ring 61 and annularly disposed apart from each other around the hand-turning ring 61. The axial fixing cylinder 60 is located around the plunging rod 51, and the inner end of the axial fixing cylinder 60 is attached to a top of the limit portion 53 when the plunger 50 moves upward. The external thread on the axial fixing cylinder 60 engages with the inner thread that is in the barrel 10 and adjacent to the mounting opening 12.

The cap 70 is cylindrical. A cap recess 71 is formed in an end of the cap 70. An annularly protruded portion 72 is annularly formed on a side wall of the cap recess 71. The cap 70 selectively covers the plunger 50, and the annularly protruded portion 72 of the plunger 50 engages with the engaging recess 13 of the cap 10.

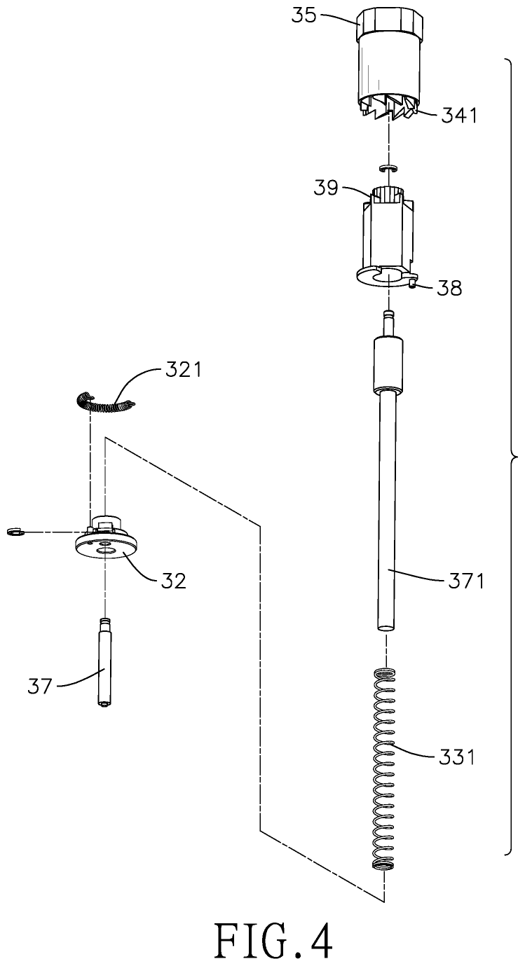

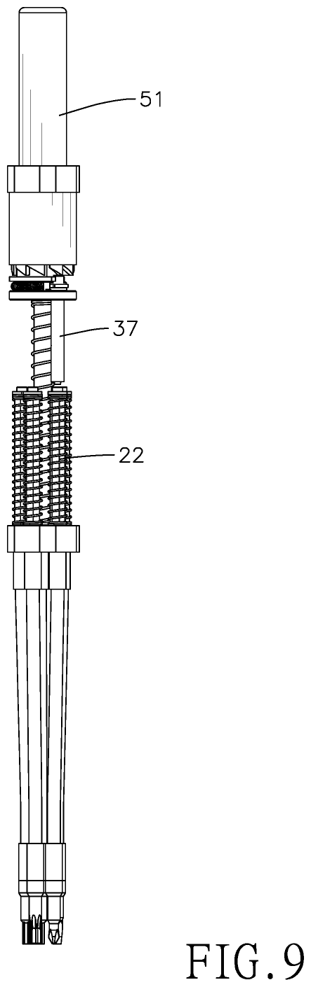

With reference to FIG. 4 and FIG. 9, when the present invention is in use, the abutting rod 37 is aligned with one of the screwdriver-bit shafts 22 while the plunging rod 51 is in an unpressed state. The screwdriver-bit shafts 22 are retracted inside the barrel 10 in the unpressed state.

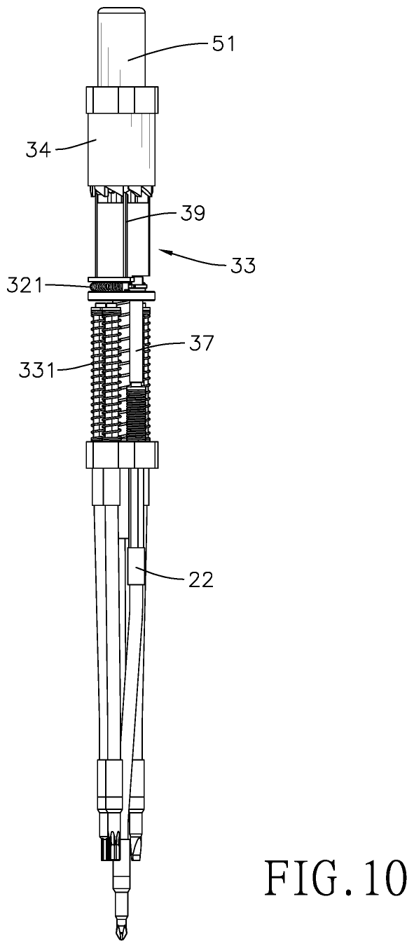

With reference to FIG. 4 and FIG. 10, when a user presses the plunging rod 51, the inner-cam tooth 52 pushes the follower teeth 39 to force the switching module 33 to protrude from the outer cam teeth of the outer cam cylinder 34.

When the follower teeth 39 of the switching module 33 tend to separate from the outer cam teeth, the user releases the press on the plunging rod 51, allowing the switching module 33 to rotate clockwise relative to the outer cam cylinder 34 due to elastic force of the connecting resilient element 321. Then, elastic force of the switching resilient element 331 pushes the switching module 33 upward to move each one of the follower teeth 39 of the switching module 33 to next adjacent gap between the outer cam teeth. The abutting rod 37 abuts against one of the screwdriver-bit shafts 22 such that the screwdriver-bit shaft 22 in alignment with the abutting rod 37 protrudes from the end opening 11 of the barrel 10.

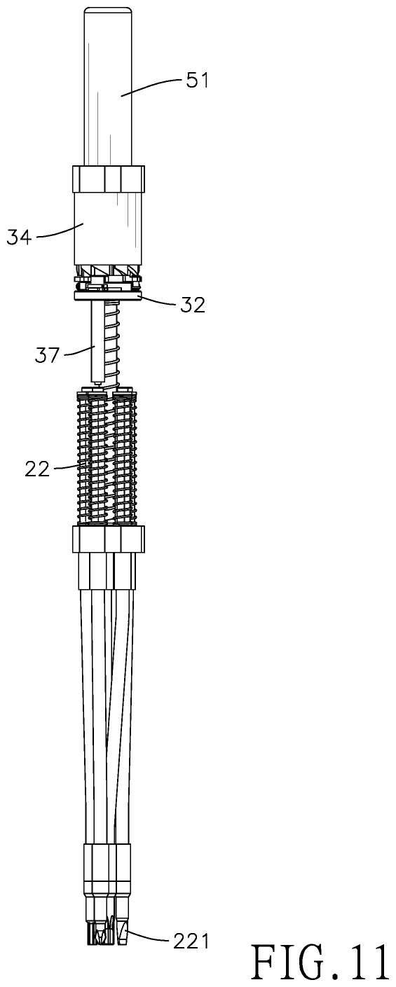

With reference to FIGS. 2, 4, and 11, when the user presses the plunging rod 51 again, the switching module 33 is rotated clockwise again, and the rotated seat 32 is rotated together with the switching module 33. When each one of the follower teeth 39 is aligned with next one of the limit grooves 40 in the outer cam cylinder 34, the follower teeth 39 are moved into the outer cam cylinder 34 along the limit grooves 40. The abutting rod 37 is now aligned with next one of the screwdriver-bit shafts 22.

In summary, a press of the plunging rod 51 makes one of the screwdriver-bit shafts 22 protrude from the end opening 11. Another press of the plunging rod 51 makes said screwdriver-bit shaft 22 retract inside the barrel 10, and also makes the abutting rod 37 align with another one of the screwdriver-bit shafts 22. The screwdriver-bit shafts 22 can protrude one by one when the user repeatedly presses the plunging rod 51. As a result, different screwdriver bits 221 can protrude from the end opening 11 for use.

The present invention is easy to carry and easy to store by accommodating different screwdriver bits 221 inside the barrel 10. Moreover, the user can quickly switch from one of the screwdriver bits 221 to another one of the screwdriver bits 221 during use, thereby further improving use efficiency. The cap 70 prevents the user from accidentally pressing the plunging rod 51 when not in use, thereby preventing the screwdriver bits 221 from protruding or retracting unexpectedly.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A screwdriver comprising:
a barrel being annular to form an accommodating space therein; the barrel having:
an end opening and a mounting opening; the end opening and the mounting opening respectively formed in two opposite ends of the barrel; the end opening and the mounting opening connected to the accommodating space; an inner diameter of the barrel gradually reducing from the mounting opening toward the end opening;
a screwdriver-bit assembly having:
a screwdriver-bit seat attached to a circumference of the mounting opening of the barrel; multiple locating holes formed through the screwdriver-bit seat; each one of the locating holes being a polygonal hole;
multiple screwdriver-bit shafts mounted in the accommodating space via the mounting opening; each one of the screwdriver-bit shafts mounted through a respective one of the locating holes of the screwdriver-bit seat, and having:
a flexible shaft;
a screwdriver bit; and
a moving portion; the screwdriver bit and the moving portion respectively located on two opposite ends of the flexible shaft; the moving portion mounted through the corresponding locating hole; and
multiple screwdriver-bit resilient elements; each one of the screwdriver-bit resilient elements located around a respective one of the moving portions of the screwdriver-bit shafts; two opposite ends of each one of the screwdriver-bit resilient elements being respectively a first end and a second end; the first end attached to the screwdriver-bit seat; the second end fixed to the corresponding moving portion; and
a push assembly having:
an abutting mechanism connected to the screwdriver-bit seat;
an abutting rod mounted on one of two ends of the abutting mechanism and selectively aligned with one of the screwdriver-bit shafts; and
a plunger; an inner end of the plunger connected to the other end of the abutting mechanism;
wherein when the screwdriver-bit shafts are retracted inside the barrel, a press of the plunger forces the abutting mechanism to abut against the abutting rod such that the screwdriver-bit shaft in alignment with the abutting rod protrudes from the end opening of the barrel; when one of the screwdriver-bit shafts protrudes from the end opening of the barrel, another press of the plunger makes said screwdriver-bit shaft retract inside the barrel and makes the abutting rod align with another one of the screwdriver-bit shafts.

2. The screwdriver as claimed in claim 1, wherein
the screwdriver-bit seat has a center hole; the center hole is formed through the screwdriver-bit seat; the locating holes are annularly disposed apart from each other around the center hole;
the abutting mechanism has:
a rotated seat; the abutting rod mounted on a bottom surface of the rotated seat;
a switching module having
an aligning rod and a cam-follower block; the aligning rod and the cam-follower block respectively located on two opposite ends of the switching module; the cam-follower block protruding from the switching module and surrounding the switching module; the aligning rod of the switching module mounted in the center hole; and
a switching resilient element located around the aligning rod and located between the screwdriver-bit seat and the rotated seat.

3. The screwdriver as claimed in claim 2, wherein
the rotated seat has
a mounting cylinder formed on and protruding from a top surface of the rotated seat; the mounting cylinder being hollow and having a mounting hole formed through a center of the rotated seat;
a first connecting pin located outside of the mounting cylinder;
a second connecting pin is formed on the cam-follower block; and
the abutting mechanism has a connecting resilient element; one of two ends of the connecting resilient element is hooked to the first connecting pin;
the other end of the connecting resilient element is hooked to the second connecting pin of the cam-follower block.

4. The screwdriver as claimed in claim 2, wherein
the screwdriver has an outer cam cylinder being hollow; the outer cam cylinder has
a cam end and a mounting end; the cam end and the mounting end formed on two opposite ends of the outer cam cylinder; the mounting end being a polygonal ring;
multiple outer cam teeth formed on the cam end; and
multiple limit grooves formed in an inner surface of the outer cam cylinder and extending along an axial direction of the outer cam cylinder; and
multiple follower teeth protrude from the cam-follower block and extend along an axial direction of the cam-follower block; the follower teeth are annularly disposed apart from each other around the cam-follower block;
each one of the follower teeth is mounted in a respective one of the limit grooves.

5. The screwdriver as claimed in claim 3, wherein
the screwdriver has an outer cam cylinder being hollow; the outer cam cylinder has
a cam end and a mounting end; the cam end and the mounting end formed on two opposite ends of the outer cam cylinder; the mounting end being a polygonal ring;
multiple outer cam teeth formed on the cam end; and
multiple limit grooves formed in an inner surface of the outer cam cylinder and extending along an axial direction of the outer cam cylinder; and
multiple follower teeth protrude from the cam-follower block and extend along an axial direction of the cam-follower block; the follower teeth are annularly disposed apart from each other around the cam-follower block; each one of the follower teeth is mounted in a respective one of the limit grooves.

6. The screwdriver as claimed in claim 4, wherein
the screw driver has an axial fixing cylinder being hollow; the axial fixing cylinder has
a hand-turning ring formed on an outer end of the axial fixing cylinder;
multiple friction recesses formed in the hand-turning ring and annularly disposed apart from each other around the hand-turning ring; and
an external thread formed on an inner end of the axial fixing cylinder;
a plunging rod is formed on an outer end of the plunger;
multiple inner-cam teeth and a limit portion are formed on the inner end of the plunger; the inner-cam teeth are formed on an end surface of the plunger and annularly arranged around a center of said end surface; the limit portion protrudes from an outer surface of the plunger; the limit portion has a polygonal outer annular surface around the plunger; the limit portion corresponds in shape to the mounting end of the outer cam cylinder; and
an inner thread is formed in an inner surface of the barrel; the inner thread is adjacent to the mounting opening;
wherein
the limit portion is mounted in the mounting end;
the axial fixing cylinder is located around the plunging rod; the external thread on the axial fixing cylinder engages with the inner thread in the barrel;
the inner end of the axial fixing cylinder is attached to the limit portion.

7. The screwdriver as claimed in claim 5, wherein
the screw driver has an axial fixing cylinder being hollow; the axial fixing cylinder has
a hand-turning ring formed on an outer end of the axial fixing cylinder;
multiple friction recesses formed in the hand-turning ring and annularly disposed apart from each other around the hand-turning ring; and
an external thread formed on an inner end of the axial fixing cylinder;
a plunging rod is formed on an outer end of the plunger;
multiple inner-cam teeth and a limit portion are formed on the inner end of the plunger; the inner-cam teeth are formed on an end surface of the plunger and annularly arranged around a center of said end surface; the limit portion protrudes from an outer surface of the plunger; the limit portion has a polygonal outer annular surface around the plunger; the limit portion corresponds in shape to the mounting end of the outer cam cylinder; and
an inner thread is formed in an inner surface of the barrel; the inner thread is adjacent to the mounting opening;
wherein
the limit portion is mounted in the mounting end;
the axial fixing cylinder is located around the plunging rod; the external thread on the axial fixing cylinder engages with the inner thread in the barrel;
the inner end of the axial fixing cylinder is attached to the limit portion.

8. The screwdriver as claimed in claim 6, wherein
the screwdriver has a cap being cylindrical; the cap having
a cap recess formed in an end of the cap;
an annularly protruded portion annularly formed on a side wall of the cap recess; and
an engaging recess is annularly formed in an outer surface of the barrel; the engaging recess is adjacent to the mounting opening;
wherein the cap selectively covers the plunger and the annularly protruded portion of the plunger engages with the engaging recess of the cap.

9. The screwdriver as claimed in claim 7, wherein
the screwdriver has a cap being cylindrical; the cap having
a cap recess formed in an end of the cap;
an annularly protruded portion annularly formed on a side wall of the cap recess; and
an engaging recess is annularly formed in an outer surface of the barrel; the engaging recess is adjacent to the mounting opening;
wherein the cap selectively covers the plunger and the annularly protruded portion of the plunger engages with the engaging recess of the cap.
